(19) United States
(12) Patent Application Publication
(10) Pub. No.: US 2011/0087589 A1
(43) Pub. Date: Apr. 14, 2011

(54) Debit or Credit Card Data Transaction Methods and Devices

(75) Inventors: Derek Wing Cheong CHAN, Tsuen Wan (HK); Alan MORGAN, Chicago, IL (US)

(73) Assignee: BBPOS Limited, Tsuen Wan (HK)

(21) Appl. No.: 12/577,050

(22) Filed: Oct. 9, 2009

(51) Int. Cl. G06Q 40/00; H04W 4/00

(52) U.S. Cl. 705/39; 455/466

(57) ABSTRACT

Debit or credit card transaction data includes one or a combination of digital card data read from a debit or credit card, transaction amount, shop identification information, and personal identification information like PIN numbers. This card transaction 5 data is in digital form. Where sales are performed on-the-go, it is now necessary to contact the card data center manually to obtain necessary information, for example approval code for the sales. Although it seems straight forward to send the digital card data over a mobile phone to resolve this issue, this approach has various problems including lack of support of all mobile 10 phones for data communication, expensive subscription fee to data plan is required, and unbounded delay in the transaction time. The current invention provides a method for performing debit or credit card transactions over mobile phone networks. In the method of the current invention, digital card transaction data is converted into audio signal suitable for transmission over voice channel of mobile phone network. The audio signal is then digitized 15 and transmitted over voice channel of mobile phone network, and then the digital card transaction data is recovered from the digitized audio signal.

### FIELD OF THE INVENTION

This invention relates to methods and devices for mobile sales, particularly those using debit or credit card, more particularly those using mobile phone.

### BACKGROUND OF THE INVENTION

Conventionally, sales involving debit or credit card data require transmission of card transaction data from the point-of-sales (POS) to the card data center by traditional telephone line. The card transaction data, which is in digital form, includes, but is not limited to, one or a combination of the following: digital card data read from a debit or credit card, transaction amount, shop identification information, and personal identification information like PIN numbers. As traditional telephone line is designed to transmit analog signal only, a modem is required to convert the digital card data into analog form like audio tones. At the card data center, these analog audio tones will be converted back into digital form for processing the transaction.

Where sales are performed on-the-go or away the POS, it is now necessary to contact the card data center manually to obtain necessary information, for example approval code for the sales. Although it seems straight forward to send the digital card data over a mobile phone to resolve this issue, this approach has the following problems:
1. The mobile phone must support data communication, which is not available in all mobile phones, particularly low cost models.
2. Subscription to data plan is required, which is more expensive and subject to geographical coverage.
3. Currently, different models of mobile phone have different connectors and protocols for connecting an external device like a credit card reader. Therefore, it is necessary to develop connection device and protocol for each model of mobile phones to interface with the external device.
4. It is necessary to install specific software to the mobile phone, which would be complicated and difficult to be maintained.
5. Digital data transmission through mobile is packet-switching based which has unbounded delay. In some cases the transaction time could become unacceptably high.

### OBJECTS OF THE INVENTION

Therefore, it is an object of this invention to resolve at least one or more of the problems as set forth in the prior art. Particularly, it is an object of the current invention to provide methods and devices for transmitting card transaction data over mobile phone that can be implemented relatively easily and at low cost. As a minimum, it is an object of this invention to provide the public with a useful choice.

### SUMMARY OF THE INVENTION

Accordingly, this invention provides a debit or credit card transaction method, including the steps of converting digital card transaction data into audio signal. The digital card transaction data includes, but is not limited to, one or a combination of the following: digital card data read from a debit or credit card, transaction amount, shop identification information, and personal identification information. The audio signal is then digitized and then transmitted over voice channel of mobile phone network. The digital card transaction data is then recovered from the digitized audio signal.

Preferably, the digital card transaction data is converted into the audio signal including an error correction scheme. More preferably, the error correction scheme includes adding an error correction coding to the digital card transaction data. Yet more preferably, the error correction coding is selected from the group consisting of Block Codes, Convolutional Code, Turbo Code, and their combinations.

Optionally, the digital card transaction data is converted into the audio signal including a modulation scheme for withstanding signal distortion. More preferably, the modulation scheme is selected from the group consisting of Multi-tone Multi-Frequency, Multiple Frequency-Shift Keying, Multiple Phase-Shift Keying, Differential Multiple Phase-Shift Keying and Differential Quadrature Phase Shift Keying.

Advantageously, the data rate of the audio signal is at least 500 bits per second.

Additionally, the volume of the audio signal is adjusted.

It is another aspect of the current invention to provide a debit or credit card transaction device for debit or credit card transaction over mobile phone network. This device includes a converter for digital card transaction data into audio signal, said digital card transaction data includes one or a combination of the following: digital card data read from a debit or credit card, transaction amount, shop identification information, and personal identification information. The device also includes an interface for transmitting the audio signal to a mobile phone for digitizing the audio signal to digitized audio signal and for transmitting the digitized audio signal over voice channel of mobile phone network.

### BRIEF DESCRIPTION OF THE DRAWINGS

Preferred embodiments of the present invention will now be explained by way of example and with reference to the accompanying drawings in which:

FIG. 1 shows the system block diagram of an exemplary system of the current invention; and

FIG. 2 shows the scheme of converting digital debit or credit card data for transmission over mobile phone network.

### DETAILED DESCRIPTION OF THE PREFERRED EMBODIMENTS

This invention is now described by way of example with reference to the figures in the following paragraphs. Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions.

In the current invention, it was found that using the digital voice channel of the mobile phone network is a feasible solution to the problem in the prior art. However, the following challenges in this solution were also found:
1. Mobile phones and telephony networks perform many operations on audio signal, such as echo cancellation, background noise reduction, comfort noise generation and volume control, which will distort the signal.
2. Mobile phones compress the voice signal using codec like Linear Predictive Coding, which distorts the audio signal.
3. Volume level in mobile phones can be adjusted or scaled, which will vary the signal at receiving end.
4. Voice channel of mobile phones allows voice packet drop, which would result in loss of some voice data.

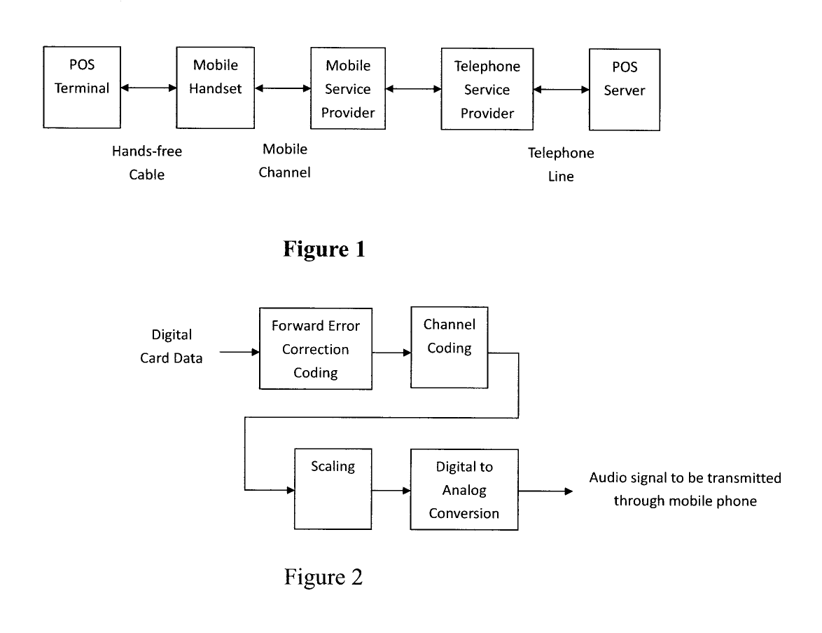

In the current invention, methods of transmission of digital card data using the voice channel of mobile phone networks were devised focusing on at least resolving part of the above problems. The transmission of card data between various devices and systems according to the current invention is shown in FIG. 1. At the Point-of-Sale (POS) terminal of the current invention, card transaction data digital card data is converted to suitable audio signal for transmission through the mobile handset or mobile phone. The card transaction data, which is in digital form, one or a combination of the following: digital card data read from a debit or credit card, transaction amount, shop identification information, and personal identification information like PIN numbers. This suitable audio signal is then transmitted through the mobile phone network operated by the mobile service provider to an optional POS server of the current invention. Telephone service provider may optionally be involved if the POS server is connected to a conventional telephone land line, which may be preferred due to ease of setting up and lower cost than connecting the POS server directly through a mobile phone network. At the POS server, the suitable audio signal is recovered or converted back to digital form, which is then passed to the card data center for further processing of the card transaction. The POS Server can then send back an acknowledgement or result of the transaction using the same method but in a reverse order to the transaction device. In such a way, debit or credit card transactions can be done through mobile phone relatively easily. Further subscription to data plan of the mobile phone network could be avoided, and thus reducing the overall costs.

FIG. 2 shows the processes involved in converting the digital card data to suitable audio signal for transmission through mobile phone network according to the current invention. After the digital card transaction data is ready to be sent, for example after digital card data is read from the debit or credit card, a forward error correction coding (FEC) is applied or added to the digital card transaction data. The FEC used in the current invention can be Block Codes, Convolutional Code, Turbo Code, or their combinations, which is known in the art. The digital card transaction data is then modulated or translated to be suitable for communication over the voice channel of the mobile phone networks. The selection of the signal representation should result in efficient symbols with reasonable data rate, and strong enough to withstand the distortion of signal causes by the various processing and compression while giving low symbol error rate. It was found that known Multi-tone Multi-Frequency (MTMF), Multiple Frequency-Shift Keying (MFSK), Multiple Phase-Shift Keying (MPSK), Differential MPSK and Differential Quadrature Phase Shift Keying (DQPSK) can be used for the current invention. The resulting target data rate of the modulated digital card data is at least 500 bits/second. This modulated digital card transaction data can then be converted to analog audio signal by known digital to analog conversion methods. Although the above steps could be performed by various different separate devices, it would be more convenient if a single device could be used instead. This single device includes an error correction code encoder for adding an error correction coding to the digital card data; a modulator for modulating the digital card data with a modulation for withstanding signal distortion; and a convertor for converting the digital card data to the audio signal. Known error correction code encoders, modulators and digital-to-analog converters can be used in this device of the current invention.

The resulting analog audio signal can then be passed to the mobile phone by placing the above device of the current invention near to the microphone of the mobile phone. More preferably, as shown in FIG. 1, the resulting analog audio signal is transferred to the mobile phone through a suitable interface for more secure and reliable audio signal transmission. The interface connects the device with the mobile phone and transmits the audio signal between the device and the mobile phone through, for example, a hands-free cable.

An optional scaling step can be incorporated in the method of the current invention, which may involve a training session for the transaction device terminal and server to know the volume level setting for the uplink and downlink. The volume can then be adjusted by a volume controller so that the audio signal can be sent from the mobile phone in the same volume level. This scaling step can occur before or after the digital-to-analog conversion step. This process and the scaling function are necessary if low resolution digital-to-analog convertor is used in the POS terminal of the current invention to reduce cost.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A debit or credit card transaction method, including the steps of:
converting digital card transaction data into audio signal, said digital card transaction data includes one or a combination of the following: digital card data read from a debit or credit card, transaction amount, shop identification information, and personal identification information;
digitizing the audio signal to digitized audio signal for transmission over voice channel of mobile phone network;
transmitting the digitized audio signal over voice channel of mobile phone network; and
recovering the digital card transaction data from the digitized audio signal.

2. The method of claim 1, wherein the step of converting digital card transaction data into the audio signal includes an error correction scheme.

3. The method of claim 2, wherein the error correction scheme includes adding an error correction coding to the digital card transaction data.

4. The method of claim 3, wherein the error correction coding is selected from the group consisting of Block Codes, Convolutional Code, Turbo Code, and their combinations.

5. The method of claim 1, wherein the step of converting digital card transaction data into the audio signal includes a modulation scheme for withstanding signal distortion.

6. The method of claim 5, wherein the modulation scheme is selected from the group consisting of Multi-tone Multi-Frequency, Multiple Frequency-Shift Keying, Multiple Phase-Shift Keying, Differential Multiple Phase-Shift Keying and Differential Quadrature Phase Shift Keying.

7. The method of claim 1, wherein the data rate of the audio signal is at least 500 bits per second.

8. The method of claim 1 further including the step of adjusting the volume of the audio signal.

9. A debit or credit card transaction device for debit or credit card transaction over mobile phone network, including
a converter for digital card transaction data into audio signal, said digital card transaction data includes one or a combination of the following: digital card data read from a debit or credit card, transaction amount, shop identification information, and personal identification information; and
an interface for transmitting the audio signal to a mobile phone for digitizing the audio signal to digitized audio signal and for transmitting the digitized audio signal over voice channel of mobile phone network.

10. The device of claim 9, wherein the converter includes an error correction code adder for adding an error correction coding to the digital card transaction data.

11. The device of claim 10, wherein the error correction coding is selected from the group consisting of Block Codes, Convolutional Code, Turbo Code, and their combinations.

12. The device of claim 9 further including a modulator for modulating said audio signal with a modulation for withstanding signal distortion.

13. The device of claim 12, wherein the modulation scheme is selected from the group consisting of Multi-tone Multi-Frequency, Multiple Frequency-Shift Keying, Multiple Phase-Shift Keying, Differential Multiple Phase-Shift Keying and Differential Quadrature Phase Shift Keying.

14. The device of claim 9, wherein the data rate of the audio signal is at least 500 bits per second.

15. The device of claim 9 further including a volume controller adjusting the volume of the audio signal.
